(19) United States
(12) Patent Application Publication
(10) Pub. No.: US 2014/0099458 A1
(43) Pub. Date: Apr. 10, 2014

(54) Liquid Crystalline Composition with a Metallic Appearance

(71) Applicant: Ticona LLC, Florence, KY (US)

(72) Inventors: Mark Allen Tyler, Florence, KY (US); Bruce Michael Mulholland, Hebron, KY (US)

(73) Assignee: Ticona LLC, Florence, KY (US)

(21) Appl. No.: 14/031,077

(22) Filed: Sep. 19, 2013

Related U.S. Application Data
(60) Provisional application No. 61/710,160, filed on Oct. 5, 2012.

(51) Int. Cl. C08L 91/06; C08K 3/08; B65D 25/34; C08K 5/53

(52) U.S. Cl. CPC C08L 91/06; C08K 5/53; C08K 3/08; B65D 25/34
USPC 428/35.8; 524/126; 99/432; 99/426; 220/62.11

(57) ABSTRACT

A polymer composition that contains a liquid crystalline polymer and a metallic pigment formed from metal particles and a carrier resin is provided. The polymer composition also contains an organophosphorous antioxidant that can help reduce the production of odorous compounds at high temperatures. The carrier resin used to form the metallic pigment may also be selectively controlled to minimize the production of odorous compounds. For example, the carrier resin may be a nonpolar wax with a relatively low acid value (e.g., polyolefin wax).

### RELATED APPLICATION

The present application claims priority to U.S. Provisional Application Ser. No. 61/710,160 (filed on Oct. 5, 2012), which is incorporated herein in its entirety by reference thereto.

### BACKGROUND OF THE INVENTION

Wholly aromatic thermotropic liquid crystalline polymers are known for their superior melt flow, excellent thermo-mechanical properties, and good chemical resistance. Although they possess many useful properties, problems are often experienced when attempting to form metallic-colored parts from such polymers. For instance, many conventional metal pigments tend to produce an undesirable odor at higher temperatures for which liquid crystalline polymers are particularly well suited. As such, a need currently exists for a liquid crystalline polymer composition that has a metallic-like appearance, but does not generate appreciable odors at higher temperatures.

### SUMMARY OF THE INVENTION

In accordance with one embodiment of the present invention, a liquid crystalline polymer composition is disclosed that has a metallic appearance. The polymer composition comprises a liquid crystalline polymer, metallic pigment, and organophosphorous antioxidant. The metallic pigment includes a plurality of metal particles and a carrier resin.

In accordance with another embodiment of the present invention, a method for forming a liquid crystalline polymer composition with a metallic appearance is disclosed. The method comprises forming a metallic pigment masterbatch by encapsulating a plurality of metal particles within a carrier resin and blending the metallic pigment masterbatch with a liquid crystalline polymer and an organophosphorous antioxidant.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a perspective view of one embodiment of a foodstuff article in the form of a saucepan, all or a portion of which may be formed from the polymer composition of the present invention;

FIG. 2 is a perspective view of one embodiment of a foodstuff article in the form of a cooking container, all or a portion of which may be formed from the polymer composition of the present invention;

FIG. 3 is a cross-sectional view of one embodiment of a foodstuff article in the form of a mug, all or a portion of which may be formed from the polymer composition of the present invention; and

FIG. 4 shows the gaseous peaks (in mins) for Samples 11, 12, and 16 of Example 2.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that contains a liquid crystalline polymer and a metallic pigment formed from metal particles and a carrier resin. By selectively controlling the type and relative concentration of these components, molded parts can be achieved that have a metallic appearance similar to a metal-plated part. The composition is also tailored so that it releases only a minimal amount, if any, odorous compounds (e.g., aldehydes and/or ketones) when heated to a high temperature. In this regard, the present inventors have discovered that the use of an organophosphorous antioxidant can help reduce the presence of odorous compounds. Without intending to be limited by theory, it is believed that such compounds can inhibit the formation of alkoxy and/or hydroxyl radicals produced by the decomposition of peroxides, which can be formed by the removal of a labile hydrogen from the carrier resin of the metallic pigment. In other words, the antioxidant can help decompose peroxides and hydroperoxides into stable, non-radical products. Thus, when heated to a temperature of 250° C. for 5 hours or less, for instance, the polymer composition may produce a lower amount of aldehydes and/or ketones (e.g., 2-butanone, 2-pentanone, 4-heptanone, etc.) than a polymer composition that is free of the organophosphorous antioxidant, but is otherwise identical.

Of course, other attributes of the polymer composition may also be selectively controlled to help achieve the desired combination of a metallic appearance and the reduced production of odorous compounds at high temperatures. For example, the carrier resin used to form the metallic pigment may be selectively controlled to minimize the production of odorous compounds. For example, the carrier resin may be a nonpolar wax with a relatively low acid value (e.g., polyolefin wax). The present inventors have discovered, for instance, that such a carrier resin may operate synergistically with the organophosphorous antioxidant to achieve the desired reduction in odor.

Various embodiments of the present invention will now be described in further detail.

### I. Polymer Composition

A. Liquid Crystalline Polymer

Liquid crystalline polymers are generally classified as “thermotropic” to the extent that they can possess a rod-like structure and exhibit a crystalline behavior in its molten state (e.g., thermotropic nematic state). Such polymers may be formed from one or more types of repeating units as is known in the art. The liquid crystalline polymer may, for example, contain one or more aromatic ester repeating units, typically in an amount of from about 60 mol. % to about 99.9 mol. %, in some embodiments from about 70 mol. % to about 99.5 mol. %, and in some embodiments, from about 80 mol. % to about 99 mol. % of the polymer. The aromatic ester repeating units may be generally represented by the following Formula (I):

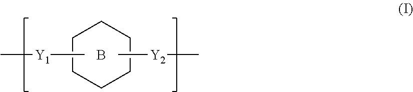

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O), wherein at least one of Y₁ and Y₂ are C(O).

Examples of aromatic ester repeating units that are suitable for use in the present invention may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 5 mol. % to about 60 mol. %, in some embodiments from about 10 mol. % to about 55 mol. %, and in some embodiments, from about 15 mol. % to about 50% of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 10 mol. % to about 85 mol. %, in some embodiments from about 20 mol. % to about 80 mol. %, and in some embodiments, from about 25 mol. % to about 75% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 30 mol. %, in some embodiments from about 2 mol. % to about 25 mol. %, and in some embodiments, from about 5 mol. % to about 20% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, dials, amides, amines, etc. Of course, in other embodiments, the polymer may be “wholly aromatic” in that it lacks repeating units derived from non-aromatic (e.g., aliphatic or cycloaliphatic) monomers.

In one particular embodiment, the liquid crystalline polymer may be formed from repeating units derived from 4-hydroxybenzoic acid (“HBA”) and terephthalic acid (“TA”) and/or isophthalic acid (“IA”), as well as various other optional constituents. The repeating units derived from 4-hydroxybenzoic acid (“HBA”) may constitute from about 5 mol. % to about 70 mol. %, in some embodiments from about 10 mol. % to about 65 mol. %, and in some embodiments, from about 15 mol. % to about 50% of the polymer. The repeating units derived from terephthalic acid (“TA”) and/or isophthalic acid (“IA”) may likewise constitute from about 5 mol. % to about 40 mol. %, in some embodiments from about 10 mol. % to about 35 mol. %, and in some embodiments, from about 15 mol. % to about 35% of the polymer. Other possible repeating units may include those derived from 6-hydroxy-2-naphthoic acid (“HNA”), 2,6-naphthalenedicarboxylic acid (“NDA”), 4,4′-biphenol (“BP”), hydroquinone (“HQ”), and/or acetaminophen (“APAP”). In certain embodiments, for example, repeating units derived from HNA, NDA, BP, HQ, and/or APAP may each constitute from about 1 mol. % to about 35 mol. %, in some embodiments from about 2 mol. % to about 30 mol. %, and in some embodiments, from about 3 mol. % to about 25 mol. % when employed.

In another embodiment, the liquid crystalline polymer may be formed from repeating units derived from 4-hydroxybenzoic acid (“HBA”), 4′-biphenol (“BP”) and/or hydroquinone (“HQ”), as well as various other optional constituents. The repeating units derived from 4-hydroxybenzoic acid (“HBA”) may constitute from about 40 mol. % to about 85 mol. %, in some embodiments from about 50 mol. % to about 80 mol. %, and in some embodiments, from about 60 mol. % to about 75% of the polymer. The repeating units derived from 4′-biphenol (“BP”) and/or hydroquinone (“HQ”) may likewise constitute from about 5 mot. % to about 40 mol. %, in some embodiments from about 10 mol. % to about 35 mol. %, and in some embodiments, from about 15 mol. % to about 35% of the polymer. Other possible repeating units may include those derived from 6-hydroxy-2-naphthoic acid (“HNA”), 2,6-naphthalenedicarboxylic acid (“NDA”), terephthalic acid (“TA”), isophthalic acid (“IA”), and/or acetaminophen (“APAP”). In certain embodiments, for example, repeating units derived from HNA, NDA, IA, TA, and/or APAP may each constitute from about 1 mol. % to about 35 mol. %, in some embodiments from about 2 mol. % to about 30 mol. %, and in some embodiments, from about 3 mol. % to about 25 mol. % when employed.

Regardless of the particular constituents and nature of the polymer, the liquid crystalline polymer may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 225° C. to about 400° C., in some embodiments from about 250° C. to about 395° C., and in some embodiments, from about 280° C. to about 380° C. For instance, one suitable technique for forming the liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 225° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 250° C. to about 350° C. The polymerization time will of course vary based on the temperature and target molecular weight. In most cases, however, the solid-state polymerization time will be from about 2 to about 12 hours, and in some embodiments, from about 4 to about 10 hours.

The resulting liquid crystalline polymer may have a relatively high melting temperature. For example, the melting temperature of the polymer may be from about 225° C. to about 400° C., in some embodiments from about 250° C. to about 395° C., and in some embodiments, from about 280° C. to about 380° C. While having a relatively high melting temperature, the polymer can maintain a relatively low melt viscosity. The melt viscosity of the liquid crystalline polymer may, for instance, be about 250 Pa-s or less, in some embodiments about 150 Pa-s or less, and in some embodiments, from about 20 to about 125 Pa-s, determined at a shear rate of 1000 seconds⁻¹. Melt viscosity may be determined in accordance with ASTM Test No. 1238-70 at temperatures ranging from 320° C. to 370° C. depending on the melting temperature (e.g., 350° C. or 370° C.). The resulting liquid crystalline polymer may also have a high number average molecular weight (Mₙ) of about 2,000 grams per mole or more, in some embodiments from about 4,000 grams per mole or more, and in some embodiments, from about 5,000 to about 50,000 grams per mole. The intrinsic viscosity of the polymer, which is generally proportional to molecular weight, may also be relatively high. For example, the intrinsic viscosity may be about 4 deciliters per gram (“dL/g”) or more, in some embodiments about 5 dL/g or more, in some embodiments from about 6 to about 20 dL/g, and in some embodiments from about 7 to about 15 dig. Intrinsic viscosity may be determined in accordance with ISO-1628-5 using a 50/50 (v/v) mixture of pentafluorophenol and hexafluoroisopropanol, as described in more detail below.

B. Metallic Pigment

The metallic pigment of the polymer composition generally includes a plurality of metal particles. The particles may have any desired shape, such as a granular, flake (scaly), etc. To help achieve the desired metallic appearance and brightness, the particles are desirably in the form of flakes. Such flake-shaped particles may have a relatively high aspect ratio (e.g., average length or diameter divided by average thickness), such as about 4:1 or more, in some embodiments about 8:1 or more, and in some embodiments, from about 10:1 to about 2000:1. The average length or diameter of the particles may, for example, range from about 1 micrometer to about 100 micrometers, in some embodiments from about 5 micrometers to about 50 micrometers, and in some embodiments, from about 10 micrometers to about 30 micrometers. The average thickness may likewise be about 5 micrometers or less, in some embodiments from about 10 nanometers to about 2 micrometers, and in some embodiments, from about 50 nanometers to about 1 micrometer. The metal employed in the particles may be a base metal, such as aluminum, zinc, iron, magnesium, copper, nickel, etc., as well as alloys thereof. Particularly suitable are aluminum particles.

The metallic pigment of the polymer composition also includes a carrier resin that can encapsulate the metal particles, thereby providing a variety of benefits. For example, the carrier resin can enhance the ability of the particles to be handled and incorporated into the base polymer composition. In certain embodiments, the carrier resin may be pre-blended with the metal particles to form a pigment masterbatch that can later be combined with the liquid crystalline polymer. When employed, metal particles typically constitute from about 50 wt. % to about 95 wt. %, in some embodiments from about 60 wt. % to about 90 wt. %, and in some embodiments, from about 70 wt. % to about 85 wt. % of the masterbatch, and the carrier resin typically constitutes from about 5 wt. % to about 50 wt. %, in some embodiments from about 10 wt. % to about 40 wt. %, and in some embodiments, from about 15 wt. % to about 30 wt. % of the masterbatch. Of course, other components, such as the organophosphorous antioxidant, may also be incorporated into the masterbatch.

Suitable carrier resins for use in the present invention may be low molecular weight waxes, such as vegetable waxes (e.g., carnauba wax, candelilla wax, etc.), animal waxes (e.g., beeswax), modified natural waxes (e.g., paraffin waxes), montan ester waxes, polyolefin waxes, amide waxes, etc. The waxes may, for example, have a weight-average molecular weight of from about 1,000 to about 30,000 grams per mole, in some embodiments from about 1,500 to about 20,000 grams per mole, and in some embodiments, from about 2,000 to about 15,000 grams per mole. The drop point or ring/ball softening point may likewise be from about 80° C. to about 165° C., in some embodiments from about 90° C. to about 140° C., and in some embodiments, from about 110° C. to about 130° C., as determined in accordance with ASTM D 3954. Polyolefin waxes are particularly suitable. In one particular embodiment, for example, a polyethylene wax may be employed that is a homopolymer of ethylene or a copolymer of ethylene with an α-olefin comonomer, such as propene, 1-butene, 1-hexene, 1-octene, 1-octadecene, styrene, etc. Such waxes may be prepared in the presence of a Ziegler-Natta or metallocene catalyst as is known in the art.

To help minimize the production of odorous compounds (e.g., aldehydes or ketones) at high temperatures, it is generally desired that the wax (e.g., polyolefin wax) has a relatively low number of carboxylic acid groups. The number of such groups can be quantified by a measurement known as the “acid value”, which represents the mass of potassium hydroxide (KOH) in milligrams required to neutralize one gram of the resin and may be determined in accordance with ISO 2114:2000. In a typical procedure, for instance, a known amount of a sample is dissolved in an organic solvent (e.g., isopropanol), and then titrated with a solution of potassium hydroxide of a known concentration and a color indicator (e.g., phenolphthalein). In this regard, the acid value of a wax employed in the polymer composition may be about 12 mg KOH/g or less, in some embodiments about 8 mg KOH/g or less, in some embodiments from 0 to about 5 mg KOH/g, and in some embodiments, from 0 to about 3 mg KOH/g (e.g., 0 mg KOH/g). One particularly suitable low acid value polyethylene wax is a Ziegler-Natta-catalyzed polyethylene available from Clariant GmbH under the name Licowax® PE 520 (acid value is 0 mg KOH/g).

Waxes with a relatively low acid value are typically nonpolar in nature. Nevertheless, if desired, the wax employed in the polymer composition may also be chemically modified so that it is polar in nature. Such polar waxes may be obtained using techniques known in the art, such as by oxidizing a nonpolar wax with a gas (e.g., air) or by grafting a polar monomer (e.g., α,β-unsaturated carboxylic acids) to a nonpolar wax.

The relative concentration of the metallic pigment and the liquid crystalline polymer may be selectively controlled in the present invention to achieve the desired metallic appearance without adversely impacting the thermal and mechanical properties of the polymer composition. In this regard, the metallic pigment is typically employed in an amount of from about 1 wt. % to about 25 wt. %, in some embodiments from about 3 wt. % to about 20 wt. %, and in some embodiments, from about 5 wt. % to about 15 wt. %, based on the weight of liquid crystalline polymers employed in the composition. The metal particles may, for instance, be employed in an amount of from about 0.5 wt. % to about 20 wt. %, in some embodiments from about 1 wt. % to about 15 wt. %, and in some embodiments, from about 3 wt. % to about 10 wt. %, based on the weight of liquid crystalline polymers employed in the composition. The metal particles may also constitute from about 0.1 wt. % to about 15 wt. %, in some embodiments from about 1 wt. % to about 10 wt. %, and in some embodiments, from about 2 wt. % to about 8 wt. % of the entire polymer composition. Further, the carrier resin may be employed in an amount of from about 0.2 wt. % to about 15 wt. %, in some embodiments from about 0.3 wt. % to about 6 wt. %, and in some embodiments, from about 0.5 wt. % to about 3 wt. %, based on the weight of liquid crystalline polymers employed in the composition. The carrier resin may also constitute from about 0.1 wt. % to about 10 wt. %, in some embodiments from about 0.2 wt. % to about 5 wt. %, and in some embodiments, from about 0.4 wt. % to about 2 wt. % of the entire polymer composition. Liquid crystalline polymers typically constitute from about 50 wt. % to about 98 wt. %, in some embodiments from about 60 wt. % to about 95 wt. %, and in some embodiments, from about 65 wt. % to about 85 wt. % of the polymer composition.

C. Antioxidant

In addition to the components noted above, the polymer composition of the present invention also contains an organophosphorous antioxidant to help reduce the amount of odorous compounds that are released at high temperatures. Without intending to be limited by theory, the present inventors believe that such antioxidants can inhibit the formation of alkoxy and/or hydroxyl radicals produced by the decomposition of peroxides, which can be formed when a labile hydrogen is removed from the polymer backbone of the carrier resin for the metal particles. Trivalent organophosphorous compounds (e.g., phosphites or phosphonites) are particularly useful in the present invention. Particularly suitable are aryl phosphonites (mono- or di-) that contain C₁ to C₁₀ alkyl substituents. These substituents may be linear (as in the case of nonyl substituents) or branched (such as isopropyl or tertiary butyl substituents). In one embodiment, for example, the aryl phosphonite has the following general formula (I):

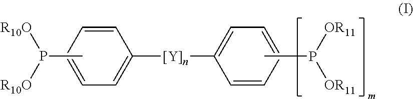

wherein,

m is 0 or 1;

n is 0 or 1;

R₁₀ and R₁₁ are independently an aliphatic, alicyclic or aromatic group of to 24 carbon atoms, optionally further substituted (e.g., by linear or branched aliphatic groups or alkaryl substituents), or both groups R₁₀ and/or R₁₁ form a cyclic group with a single phosphorus atom;

Y is —O—, —S—, —CH(R₁₅)— or —C₆H₄—, where R₁₅ is hydrogen, C₁₋₆ alkyl, or COOR₆ and R₆ is C₁₋₁₈ alkyl.

If desired, m may be 1 so that the compound is a diphosphonite compound. For example, the diphosphonite compound may have the following general formula (x):

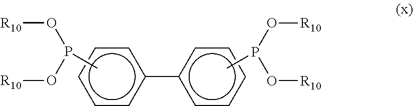

wherein R₁₀ and R₁₁ are as defined above. For instance, R₁₀ and R₁₁ may independently be linear, branched or cyclic C₁₋₂₄ aliphatic groups or aromatic groups (e.g., phenyl), optionally substituted with from 1 to 4 C₁₋₁₂ alkyl or aralkyl groups. For example, R₁₀ and/or R₁₁ may be 2,4-di-tert-butylphenyl. In one particular embodiment, the diphosphonite compound may be tetrakis(2,4-di-tert-butylphenyl)biphenylene diphosphonite, which is commercially available from Clariant GmbH and under the name Hostanox® P-EPQ and has the following general structure:

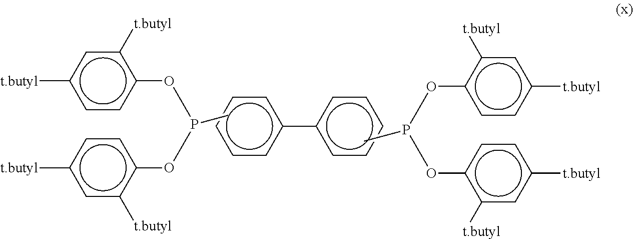

The organophosphorous antioxidant may be formed entirely of a diphosphonite compound, such as described above. Alternatively, the antioxidant may contain a mixture of diphosphonite compounds with monophosphonites and/or phosphites. In such embodiments, diphosphonite compounds typically constitute from about 50 wt. % to about 99 wt. %, in some embodiments from about 70 wt. % to about 95 wt. %, and in some embodiments, from about 75 wt. % to 90 wt. % of the organophosphorous antioxidant. Monophosphonites and/or phosphites may likewise constitute from about 1 wt. % to about 50 wt. %, in some embodiments from about 5 wt. % to about 30 wt. %, and in some embodiments, from about 10 wt. % to about 25 wt. % of the organophosphorous antioxidant.

Organophosphorous antioxidants typically constitute from about 0.05 wt. % to about 5 wt. %, in some embodiments from about 0.1 wt. % to about 3 wt. %, and in some embodiments, from about 0.4 wt. % to about 1.5 wt. %, based on the weight of liquid crystalline polymers employed in the composition. The organophosphorous compounds may likewise constitute from about 0.01 wt. % to about 4 wt. %, in some embodiments from about 0.1 wt. % to about 1.5 wt. %, and in some embodiments, from about 0.2 wt. % to about 1 wt. % of the entire polymer composition.

If desired, other antioxidants may also be employed in combination with the organophosphorous antioxidants. Sterically hindered phenolic antioxidant(s) may, for instance, be employed to help entrap any peroxy radicals generated by reaction of the carrier resin with oxygen. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl)ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); tetrakis[methylene-(3,5-di-tertbutyl-4-hydroxycinnimate)]methane (Irganox® 1010); and ethylene-bis(oxyethylene)bis[3-(5-tert-butyl-4-hydroxy-m-tolyl)-propionate (Irganox® 245); and so forth. When employed, sterically hindered phenolic antioxidants may constitute from about 0.1 wt. % to about 3 wt. %, in some embodiments from about 0.2 wt. % to about 2 wt. %, and in some embodiments, from about 0.5 wt % to about 1.5 wt. % of the polymer composition.

D. Other Additives

Besides the components noted above, the polymer composition may also employ one or more other additives. Examples of such additives may include, for instance, UV stabilizers, light stabilizers, surfactants, flow promoters, fillers, antimicrobials, and other materials added to enhance properties and processibility. For example, a filler material may be employed to enhance strength. A filler composition can include a filler material, such as a fibrous filler and/or a mineral filler. Mineral fillers may, for instance, be employed in the composition to help achieve the desired mechanical properties and/or appearance. When employed, mineral fillers typically constitute from about 5 wt. % to about 50 wt. %, in some embodiments from about 10 wt. % to about 40 wt. %, and in some embodiments, from about 15 wt. % to about 30 wt. % of the composition. For instance, clay minerals may be employed, such as talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂. 4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, other mineral fillers may also be employed, such as calcium silicate, aluminum silicate, mica, diatomaceous earth, wollastonite, alumina, silica, titanium dioxide, calcium carbonate, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

Fibers may also be employed as a filler material to further improve the mechanical properties. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. Suitable fibers may include those formed from carbon, glass, ceramics (e.g., alumina or silica), aramids (e.g., Kevfar® marketed by E.I. DuPont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof. When employed, fibrous fillers typically constitute from about 5 wt. % to about 50 wt. %, in some embodiments from about 10 wt. % to about 40 wt. %, and in some embodiments, from about 15 wt. % to about 30 wt. % of the composition.

### II. Blending

The liquid crystalline polymer, metallic pigment (e.g., metal particles and/or carrier resin), organophosphorous compound, and other optional additives may be blended together in a variety of ways to achieve the desired polymer composition. In certain embodiments, for example, the metallic pigment may initially be formed as a masterbatch from the metal particles and carrier resin, such as described above, and thereafter combined with the liquid crystalline polymer. In such embodiments, the organophosphorous antioxidant may be incorporated into the metallic pigment masterbatch or simply blended together with the masterbatch and liquid crystalline polymer. Alternatively, the individual components of the composition may also be blended together without first forming a masterbatch from the metal particles and carrier resin.

Regardless of how they are supplied, the components of the polymer composition are generally blended together to form the polymer composition. Blending may occur at a temperature at or near the melting temperature of the liquid crystalline polymer, such as at a temperature of from about 225° C. to about 400° C., in some embodiments, from about 250° C. to about 395° C., and in some embodiments, from about 280° C. to about 380° C. Any of a variety of melt blending techniques may generally be employed in the present invention. For example, the components may be melt blended within an extruder that includes at least one screw rotatably mounted and received within a barrel (e.g., cylindrical barrel). The extruder may be a single screw or twin screw extruder. If desired, one or more distributive and/or dispersive mixing elements may be employed within the mixing and/or melting sections of the extruder. Suitable distributive mixers for single screw extruders may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin mixers.

### III. Applications

Once formed, the resulting polymer composition may be shaped into any of a variety of different parts using techniques as is known in the art, such as injection molding, compression molding, blow molding, thermoforming, etc. For example, the parts may be molded using a one-component injection molding process in which dried and preheated plastic granules are injected into the mold. Regardless of the shaping technique employed, it has been discovered that the resulting parts may exhibit a metallic-like appearance. The metallic appearance may be characterized in a variety of different ways. For example, the surface may exhibit a specular gloss of about 10 gloss units or more, in some embodiments about 30 gloss units or more, in some embodiments about 45 gloss units or more, in some embodiments 50 gloss units or more, and in some embodiments, about 55 gloss units or more, as determined in accordance with ASTM D523-08 at a 60° angle using a gloss meter. The part may also have a grayish, metallic-like color similar to many metals, such as those made from cast iron, aluminum, carbon steel, stainless steel (i.e., steel alloy with approximately 10.5% to 11% chromium content by mass), etc. This similarity in color can be quantified by measuring the absorbance with an optical reader in accordance with a standard test methodology known as “CIELAB”, which is described in Pocket Guide to Digital Printing by F. Cost, Delmar Publishers, Albany, N.Y. ISBN 0-8273-7592-1 at pages 144 and 145 and “Photoelectric color difference meter”, Journal of Optical Society of America, volume 48, page numbers 985-995, S. Hunter, (1958), both of which are incorporated herein by reference in their entirety. More specifically, the CIELAB test method defines three “Hunter” scale values, L*, a*, and b*, which correspond to three characteristics of a perceived color based on the opponent theory of color perception and are defined as follows:

L*=Lightness (or luminosity), ranging from 0 to 100, where 0=dark and 100=light;

a*=Red/green axis, ranging from −100 to 100; positive values are reddish and negative values are greenish; and

b*=Yellow/blue axis, ranging from −100 to 100; positive values are yellowish and negative values are bluish.

Because CIELAB color space is somewhat visually uniform, a single number may be calculated that represents the total absolute color difference between two colors as perceived by a human using the following equation:

ΔE=[(ΔL*)²+(Δa*)²+(Δb*)²]^{1/2}

wherein, ΔL* is the luminosity value of a first color subtracted from the luminosity value of a second color, Δa* is the red/green axis value of the first color subtracted from the red/green axis value of the second color; and Δb* is the yellow/blue axis value of the first color subtracted from the yellow/blue axis value of the second color. In CIELAB color space, each ΔE unit is approximately equal to a “just noticeable” difference between two colors and is therefore a good measure for an objective device-independent color specification system that may be used for the purpose of expressing differences in color. For instance, the “first color” in the formula above may represent the color of a metal part (e.g., stainless steel) and the “second color” may represent the color of the polymer composition and/or a shaped part formed therefrom. Due to the relatively close color between parts formed from the polymer composition of the present invention and those formed from metal, the resulting ΔE values are typically small, such as about 12 or less, in some embodiments about 11 or less, in some embodiments, from about 0.5 to about 8, and in some embodiments, from about 1 to about 6.

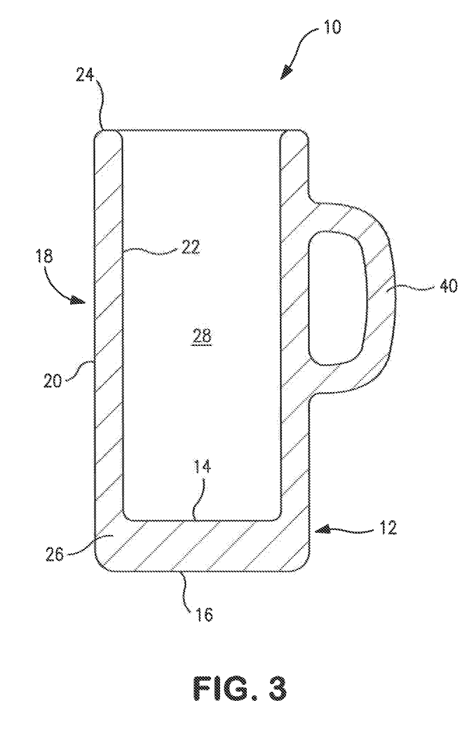

Various different types of articles may be made from shaped parts and/or polymer compositions of the present invention. Although any suitable shaped part can be formed, the polymer composition of the present invention is particularly well suited for producing foodstuff articles, such as noted above. Referring to FIG. 3, for instance, one particular embodiment of a foodstuff article that may be formed in accordance with the present invention is shown in the shape of a mug 10. As illustrated, the mug 10 has a bottom wall 12, sidewall 18, and a handle 40. The bottom wall 12 defines an interior surface 14 and an exterior surface 16 and the sidewall 18 likewise defines an exterior surface 20 and an interior surface 22, as well as a top open end 24 and a bottom closed end 26. The sidewall 18 extends from the top open end 24 to the bottom closed end 26 where it is connected to the bottom wall 12 and defines a hollow interior 28 for receiving a beverage. In one embodiment, the mug 10, including sidewall 18 and bottom wall 12, are generally cylindrical in shape. Any portion of the mug 10 may generally be formed from the polymer composition of the present invention, such as the bottom wall 12, sidewall 18, and/or handle 40. In some embodiments, the entire mug is formed from the polymer composition of the present invention so that it has a metallic appearance.

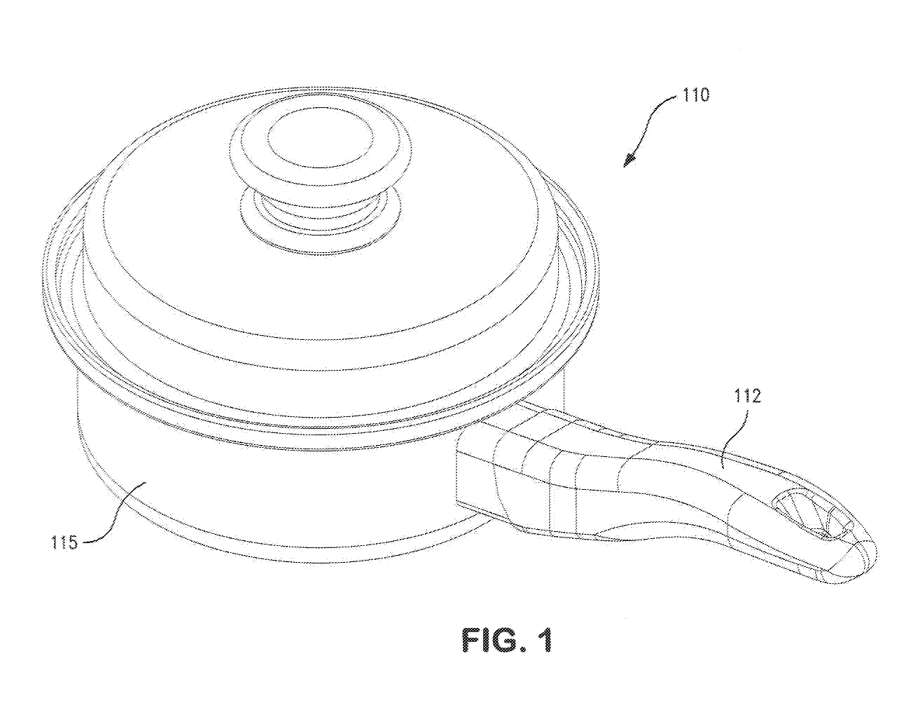

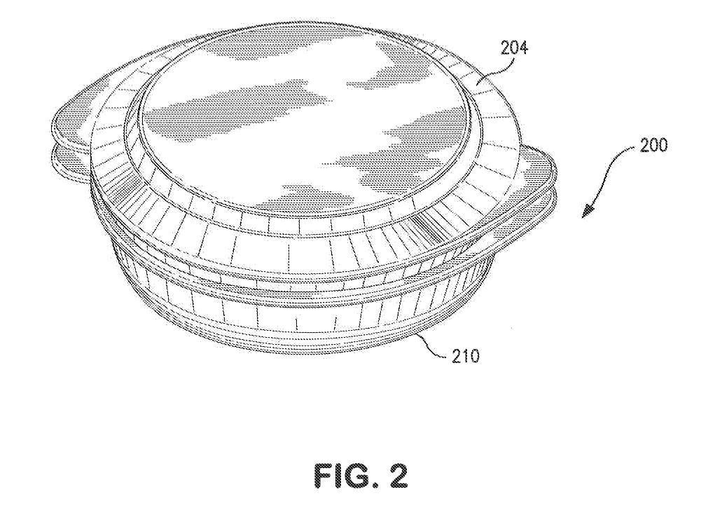

Foodstuff articles used for food preparation, such as cookware and bakeware, are also particularly well adapted for use with a shaped part formed from the polymer composition of the present invention. The polymer composition of the present invention may, for instance, be used to produce all or a portion of cookware (e.g., cooking utensils, beverage containers, braising pans, roasting pans, casserole pans, dutch ovens, frying pans, skillets, wonder pots, griddles, saucepans, sauté pans, stockpots, woks, etc.) and/or bakeware (e.g., cake pan, sheet pan, cookie sheet, jelly-roll pan, muffin pan, pie pan, bun pan, bread pan, etc.). When formed from the polymer composition of the present invention, such articles can be capable of withstanding high temperatures and also be chemical resistant and exceptionally inert. In certain embodiments, for example, the polymer composition of the present invention may be used to form a handle, cover, or lid of cookware or bakeware. Alternatively, the polymer composition may be used to form a cooking surface of the cookware or bakeware. Referring to FIG. 1, for instance, one embodiment of cookware 10 is shown that contains a handle 12 connected to a cooking vessel 15. If desired, the polymer composition of the present invention may be used to form all or a portion of the handle 12 and/or vessel 15. In the embodiment illustrated in FIG. 1, the cookware is in the form of a saucepan; however, it should be understood that a wide variety of other cookware articles may also be employed. Referring to FIG. 2, for instance, a cooking container 200 is shown that contains a lid 204 that is configured to be disposed over a base 210. Once again, as noted above, the polymer composition of the present invention may be used to form all or a portion of the lid 204 and/or the base 210.

The present invention may be better understood with reference to the following examples.

### Example 1

Liquid crystalline polymer samples are formed to determine the impact of various wax resins and organophosphorous antioxidants on odor. Glycolube® P (pentaerythritol tetrastearate); A-C® 629 (oxidized polyethylene homopolymer); Licowax® PP 1302 (metallocene polypropylene wax); Licomont® NAV 101 (sodium soap of montanic acids); and Licowax® PE 520 (polyethylene wax) are employed as the wax resins. Hostanox® P-EPQ (disphosphonite) is employed as the organophosphorous antioxidant. The constituents and concentrations of each of the samples are set forth below in Table 1. Odor evaluation is also conducted by a 3 person panel who subjectively grades the smell on a scale of 0 to 5, with 0 representing the least amount of odor and 5 representing the highest amount of odor. The results of the odor testing are also set forth below in Table 1.

TABLE 1

| Sample | 1 | 2 | 3 | 4 | 5 | 6 | 7 | 8 | 9 | 10 |
|---|---|---|---|---|---|---|---|---|---|---|
| Vectra ® | 80.0 | 78.8 | 78.8 | 78.8 | 78.8 | 78.3 | 78.8 | 78.3 | 77.8 | 77.3 |
| E950iSX | | | | | | | | | | |
| Mica | 20.0 | 20.0 | 20.0 | 20.0 | 20.0 | 20.0 | 20.0 | 20.0 | 20.0 | 20.0 |
| Glycolube P¹ | | 1.20 | | | | | | | | |
| AC-629 | | | 1.2 | | | | | | | |
| Licowax 1302 | | | | 1.2 | | | | | | |
| Licomont NAV | | | | | 1.2 | 1.2 | | | | |
| 101 | | | | | | | | | | |
| Licowax ® PE | | | | | | | 1.2 | 1.2 | 1.2 | 1.2 |
| 520 | | | | | | | | | | |
| Hostanox ® P- | | | | | | 0.5 | | 0.5 | 1.0 | 1.5 |
| EPQ | | | | | | | | | | |
| Total | 100.0 | 100.0 | 100.0 | 100.0 | 100.0 | 100.0 | 100.0 | 100.0 | 100.0 | 100.0 |
| Odor evaluation | 1 | 5 | 4-5 | 4 | 4 | 3-4 | 3-4 | 1-2 | 2-3 | 3-4 |
| (0-5) | | | | | | | | | | |

### Example 2

Metallic liquid crystalline polymer samples are formed from various combinations of Vectra® E950iSX (liquid crystalline polymer), mica, Hostanox® P-EPQ (disphosphonite antioxidant), and aluminum pigments. MS MP15 20B (aluminum flakes encapsulated in polyolefin wax, Eckart GmbH), Sparkle Silvet® 880-20-E (aluminum flakes encapsulated in polyethylene wax, Silberline Mfg. Co, Inc.); and aluminum flakes encapsulated in Licowax® PE 520 are employed as aluminum pigments. The constituents and concentrations of each of the samples are set forth below in Table 2.

TABLE 2

| Sample | 11 | 12 | 13 | 14 | 15 | 16 | 17 | 18 | 19 |
|---|---|---|---|---|---|---|---|---|---|
| Vectra ® E950iSX | | 74.0 | 74.0 | 74.7 | 74.45 | 74.2 | 73.7 | 78.3 | 77.8 |
| Mica | | 20.0 | 20.0 | 20.0 | 20.00 | 20.0 | 20.0 | 20.0 | 20.0 |
| Hostanox ® P-EPQ | | | | | 0.25 | 0.5 | 1.0 | 0.5 | 0.5 |
| MS MP15 20B | | 6.0 | | | | | | 6.0 | |
| Sparkle Silvet ® | | | 6.0 | | | | | | 6.0 |
| 880-20-E | | | | | | | | | |
| Vectra ® J543 | 100.0 | | | | | | | | |
| VD3071 Cosmos | | | | | | | | | |
| (black LCP) | | | | | | | | | |
| Al Particles | | | | 5.3 | 5.30 | 5.3 | 5.3 | | |
| encapsulated in | | | | | | | | | |
| Licowax ® PE 520 | | | | | | | | | |
| Total | 100.0 | 100.0 | 100.0 | 100.0 | 100.00 | 100.0 | 100.0 | 100.0 | 100.0 |

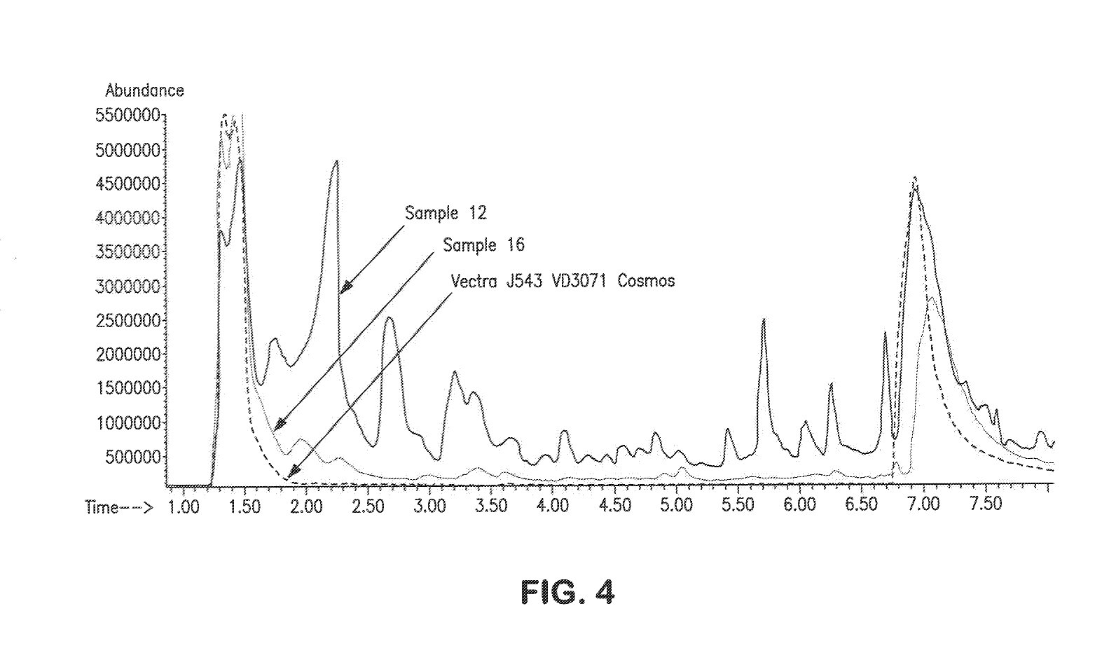

Once formed, Samples 11, 12, and 16 are tested to determine the gases produced during heating. The results are shown in FIG. 4. In FIG. 4, the identified peaks (in minutes) correspond to the following chemical compounds:

| Peak (mins) | Chemical |
|---|---|
| 1.752 | Butanal, 2-ethyl- |
| 2.253 | Acetic acid |
| 2.681 | Methyl Isobutyl Ketone |
| 3.206 | 2,4-Pentanedione |
| 3.351 | 2-petene, 3,4-dimethyl-(Z) |
| 4.103 | 2-Hexanone |
| 4.563 | 2-butanone |
| 4.838 | 2-Heptanone |
| 5.420 | 2-Pentanone, 3-ehtyl- |
| 5.711 | 2-Heptanone, 4-methyl- |
| 6.050 | 2,5-Furandione, 3-methyl- |
| 6.260 | Benzene, 1,2,3-trimethyl- |
| 6.696 | 2-Heptanone, 4,6-dimethyl- |
| 6.939 | Phenol |

The samples are also injected molded into the shape of a mug. The injection molded mugs are put in an oven, covered with a lid, and baked for 5 hours at 250° C. At the end of the 5 hours, the mugs are taken out of the oven and allowed to cool for 24 hours at room temperature. The lids are removed long enough to test the lids for odor as indicated above. The results are set forth below in Table 3.

TABLE 3

| Sample | 11 | 12 | 13 | 14 | 15 | 16 | 17 | 18 | 19 |
|---|---|---|---|---|---|---|---|---|---|
| Odor evaluation | 1 | 5 | 5 | Not | 2-3 | 1-2 | 2-3 | 5 | 4-5 |
| (0-5) | | | | determined | | | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A liquid crystalline polymer composition that has a metallic appearance, wherein the polymer composition comprises a liquid crystalline polymer, metallic pigment, and organophosphorous antioxidant, and further wherein the metallic pigment includes a plurality of metal particles and a carrier resin.

2. The liquid crystalline polymer composition of claim 1, wherein the liquid crystalline polymer contains repeating units derived from an aromatic dicarboxylic acid, aromatic hydroxycarboxylic acid, or a combination thereof.

3. The liquid crystalline polymer composition of claim 1, wherein the polymer further comprises one or more repeating units derived from an aromatic diol, aromatic amide, aromatic amine, or a combination thereof.

4. The liquid crystalline polymer composition of claim 1, wherein the liquid crystalline polymer is wholly aromatic.

5. The liquid crystalline polymer composition of claim 1, wherein the metal particles are flaked-shaped.

6. The liquid crystalline polymer composition of claim 5, wherein the flake-shaped metal particles have an aspect ratio of about 4:1 or more.

7. The liquid crystalline polymer composition of claim 1, wherein the metal particles are aluminum particles.

8. The liquid crystalline polymer composition of claim 8, wherein the wax is a wax.

9. The liquid crystalline polymer composition of claim 8, wherein the wax is a Ziegler-Natta catalyzed polyethylene wax.

10. The liquid crystalline polymer composition of claim 8, wherein the wax has a drop point of from about 80° C. to about 165° C., as determined in accordance with ASTM D 3954.

11. The liquid crystalline polymer composition of claim 8, wherein the wax is nonpolar.

12. The liquid crystalline polymer composition of claim 8, wherein the wax has an acid value of about 12 mg KOH/g or less, as determined in accordance with ISO 2114:2000.

13. The liquid crystalline polymer composition of claim 1, wherein the organophosphorous antioxidant includes an aryl phosphonite.

14. The liquid crystalline polymer composition of claim 13, wherein the aryl phosphonite has the following general formula (I): 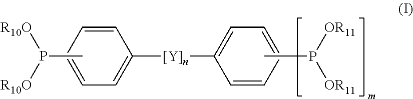
wherein,
m is 0 or 1;
n is 0 or 1;
R₁₀ and R₁₁ are independently an aliphatic, alicyclic or aromatic group of 1 to 24 carbon atoms, optionally further substituted, or wherein both groups R₁₀ and/or R₁₁ form a cyclic group with a single phosphorus atom; and
Y is —O—, —S—, —CH(R₁₅)— or —C₆H₄—, where R₁₅ is hydrogen, C₁₋₆ alkyl, or COOR₆ and R₆ is C₁₋₁₈ alkyl.

15. The liquid crystalline polymer composition of claim 14, wherein m is 1.

16. The liquid crystalline polymer composition of claim 15, wherein the organophosphorous antioxidant includes a diphosphonite compound having the following general formula (x): 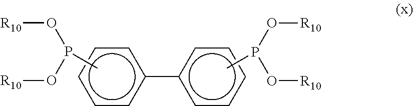
wherein R₁₀ and R₁₁ are independently linear, branched or cyclic C₁₋₂₄ aliphatic groups or aromatic groups, optionally substituted with from 1 to 4 C₁₋₁₂ alkyl or aralkyl groups.

17. The liquid crystalline polymer composition of claim 14, wherein R₁₀ and/or R₁₁ are 2,4-di-tert-butylphenyl.

18. The liquid crystalline polymer composition of claim 1, further comprising a mineral filler.

19. The liquid crystalline polymer composition of claim 1, wherein liquid crystalline polymers constitute from about 50 wt. % to about 98 wt. % of the polymer composition and the metal particles are present in an amount from about 0.5 wt. % to about 20 wt. % based on the weight of liquid crystalline polymers in the composition.

20. The liquid crystalline polymer composition of claim 1, wherein the composition produces a lower amount of aldehydes and/or ketones than a polymer composition that is free of the organophosphorous antioxidant, but is otherwise identical, when heated to a temperature of 250° C. for 5 hours.

21. A molded part that defines a surface with a metallic appearance, wherein the part comprises the liquid crystalline polymer composition of claim 1.

22. A cookware article comprising the molded part of claim 21

23. The cookware article of claim 22, wherein the article is a cooking utensil, beverage container, food tray, food container, cake pan, pie pan, cooking tray, bun pan, cooking pan, muffin pan, or bread pan.

24. A method for forming a liquid crystalline polymer composition with a metallic appearance:
forming a metallic pigment masterbatch by encapsulating a plurality of metal particles within a carrier resin; and
blending the metallic pigment masterbatch with a liquid crystalline polymer and an organophosphorous antioxidant.

25. The method of claim 24, wherein metal particles constitute from about 50 wt. % to about 95 wt. % of the masterbatch and the carrier resin constitutes from about 5 wt. % to about 50 wt. % of the masterbatch.

26. The method of claim 24, wherein the metal particles are flaked-shaped aluminum particles.

27. The method of claim 24, wherein the carrier resin is a polyolefin wax.

28. The method of claim 27, wherein the polyolefin wax is a nonpolar wax having an acid value of about 12 mg KOH/g or less, as determined in accordance with ISO 2114:2000.

29. The method of claim 24, wherein the organophosphorous antioxidant includes an aryl diphosphonite having the following general formula (x): 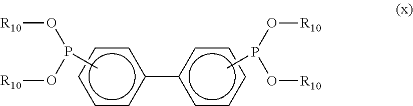
wherein R₁₀ and R₁₁ are independently linear, branched or cyclic C₁₋₂₄ aliphatic groups or aromatic groups, optionally substituted with from 1 to 4 C₁₋₁₂ alkyl or aralkyl groups.

30. The method of claim 24, wherein a mineral filler is also blended with metallic pigment, liquid crystalline polymer, and organophosphorous antioxidant.
